(19) United States
(12) Patent Application Publication
(10) Pub. No.: US 2026/0021796 A1
(43) Pub. Date: Jan. 22, 2026

(54) Method, computer program, controller for a mobile medical apparatus and mobile medical apparatus

(71) Applicant: Siemens Healthineers AG, Forchheim (DE)

(72) Inventors: Wolfgang ENGE, Bayreuth (DE); Matthias MUELLER, Bamberg (DE); Alexander BEER, Kulmbach (DE); Sebastian MAISENBACHER, Muenchen (DE)

(73) Assignee: Siemens Healthineers AG, Forchheim (DE)

(21) Appl. No.: 19/267,702

(22) Filed: Jul. 14, 2025

(30) Foreign Application Priority Data
Jul. 16, 2024 (DE) 10 2024 206 683.4

(51) Int. Cl. B60T 8/58; B60T 8/171; B60T 8/172; B62B 5/00

(52) U.S. Cl. CPC B60T 8/58; B60T 8/171; B60T 8/172; B62B 5/0066; B60T 2240/00

(57) ABSTRACT

One or more example embodiments relates to a method for braking a mobile medical apparatus having a first and second wheel, the method comprising determining a first wheel speed for the first wheel and a second wheel speed for the second wheel; determining a first braking quantity for the first wheel and a second braking quantity for the second wheel, the first braking quantity describing a strength with which the first wheel is braked and the second braking quantity describing a strength with which the second wheel is braked, wherein a smaller braking quantity is determined for a wheel with a lower wheel speed than for a wheel with a higher wheel speed among the first wheel and the second wheel; and applying the first braking quantity and the second braking quantity to brake the first wheel and the second wheel.

### CROSS-REFERENCE TO RELATED APPLICATION(S)

The present application claims priority under 35 U.S.C. § 119 to German Patent Application No. 10 2024 206 683.4, filed Jul. 16, 2024, the entire contents of which are incorporated herein by reference.

### FIELD

One or more example embodiments relates to the technical field of mobile medical apparatuses, such as the automated braking of mobile medical apparatuses with differential drive. This technology is used in numerous mobile medical apparatuses, including mobile C-arms, mobile head scanners, mobile imaging and/or therapy apparatuses.

### RELATED ART

The automated braking of mobile medical apparatuses with differential drive, referred to below also as a vehicle for short, after the release of an activation element, for instance a dead man apparatus, poses a challenge, especially when traveling around corners. Conventional approaches in which both drive wheels are braked simultaneously and with the maximum permitted deceleration lead to unpleasant behavior by the vehicle. As soon as the first wheel comes to a standstill, the vehicle swivels about this wheel, something that is compounded by the freely rotating support wheels. Users perceive this behavior as unpleasant and unsafe, in particular in the case of heavier vehicles.

A mobile medical apparatus with differential drive typically comprises two driven wheels on one axle and one or two passive, freely rotating support wheels.

### SUMMARY

The drive wheels are actuated independently of each other in order to steer the vehicle. The simplest algorithm for the braking of both wheels with maximum deceleration has proved deficient in practice because it leads to the twisting behavior described.

This problem is not solved by existing medical vehicles in which the wheels are braked independently of each other with maximum deceleration, which again leads to the twisting behavior.

At least some example embodiments provide a method, computer program, controller and medical apparatus which control the automated braking in such a way that the vehicle is brought safely and comfortably to a standstill even when traveling around a corner. The aim is also to keep the effort of implementation in the control software to a minimum. This solution is intended to minimize or completely avoid the twisting behavior regardless of the mass of the vehicle, and to increase the comfort and safety for the user.

### BRIEF DESCRIPTION OF THE DRAWINGS

It is provided in particular that features are transferable between the different categories, in particular that method features can form device features, and device features can form method features. Further advantages, effects and embodiments can be found in the accompanying figures and the description thereof, in which figures:

FIG. 1 shows an exemplary embodiment of a mobile medical apparatus;

FIG. 2 shows a segment from the mobile medical apparatus of FIG. 1 comprising a controller;

FIG. 3 shows a schematic flow diagram of the method for braking the mobile medical apparatus according to one or more example embodiments; and

FIG. 4 shows a variation over time of the wheel speeds during braking of the mobile medical apparatus according to one or more example embodiments.

### DETAILED DESCRIPTION

People of male, female or other gender identity are included regardless of the gender applied to a particular term.

The subject matter of one or more example embodiments is a mobile medical apparatus, a method, a computer program, and controller for braking the mobile medical apparatus.

The method can form a computer-implemented method and/or a method implemented by the controller. The method is for automatic braking of the mobile medical apparatus. In particular, the method is designed to brake the mobile medical apparatus during travel around a corner. The mobile medical apparatus preferably comprises a chassis and at least two driven wheels. In particular, the medical apparatus comprises at least one further wheel, which is preferably not driven. The medical apparatus comprises in particular a functional segment, which functional segment comprises, for example, a fluoroscopy unit, imaging unit or therapy unit. For example, the medical apparatus comprises a C-arm, an angiography unit, an X-ray apparatus, and/or a head scanner. The mobile medical apparatus has in particular an unladen weight of more than 200 kg, especially of more than 500 kg and optionally of more than 1000 kg. The method is designed in particular to brake the mobile medical apparatus automatically after the release of an activation element, for example a dead man element. In other words, the method is applied and/or initiated preferably only once the activation element is released and/or no longer engaged. In particular, the execution of the method is suppressed while the activation element is activated.

The mobile medical apparatus has a differential drive unit. The differential drive unit is designed to drive and/or actuate a first and a second wheel of the medical apparatus. The first and second wheels are preferably comprised by the chassis and/or attached thereto. In particular, the first and second wheels are arranged on a shared axle. The differential drive unit is designed to actuate and/or drive the first and second wheels independently of each other. In other words, the differential drive unit can drive and/or operate the first and second wheels at different speeds. In particular, the method is designed and/or configured to brake the first and second wheels, specifically the mobile medical apparatus, via the differential drive unit. In other words, the differential drive unit can also be used for braking in addition to the active acceleration and/or displacement of the medical apparatus. The method is designed specifically to actuate and/or regulate the differential drive unit for braking. The method serves specifically to prevent a twisting behavior of the medical apparatus during braking.

The medical apparatus is designed in particular to realize steering by driving and/or operating the first and second wheels at different speeds. Specifically, the first and second wheels are not actively steered wheels that are designed to be pivotable, but instead facilitate cornering by the medical apparatus through the use of different wheel speeds.

In a method step, also referred to as the first determination step, a first wheel speed for the first wheel and a second wheel speed for the second wheel are established. In particular, the first wheel speed and the second wheel speed are established simultaneously and/or in a time interval of less than one second. The determining can comprise measuring the first and/or second wheel speed. Alternatively and/or additionally, the determining of the first and second wheel speeds can comprise calculating the wheel speeds based on geometric quantities, wheel sizes and/or measured quantities. For example, the determining is performed using a first and a second sensor, with the first sensor establishing the first wheel speed and the second sensor establishing the second wheel speed. Alternatively, the first and second wheel speeds can be established via position measurements, for example by measuring the position at different points in time and knowing the wheel sizes.

In a further method step, also referred to as the second determination step, a first braking quantity for the first wheel and a second braking quantity for the second wheel are established and/or determined. The determining of the braking quantities can comprise a calculation and/or measurement. In particular, the determining and/or calculation of the first and second braking quantities comprises determining according to the first and/or second wheel speed. The first and second braking quantities form a measure of the strength with which the associated wheel is braked. The first and/or second braking quantity can comprise and/or form, for example, an acceleration, a braking torque and/or a braking force. In particular, the first and/or second braking quantity is designed to be applied by the differential drive unit. Alternatively and/or additionally, the first and/or second braking quantity is designed and/or configured to be applied by a braking apparatus. Specifically, the determining of the first braking quantity is performed on the basis of the first and second wheel speeds. In addition, it is preferably provided that the determining of the second braking quantity is performed on the basis of the first and second wheel speeds. It is provided here that a smaller braking quantity is determined and/or established for the wheel that has the lower wheel speed, and a larger braking quantity is established for the wheel that has the higher wheel speed. For example, the first wheel has a higher wheel speed; thus the first wheel speed is higher than the second wheel speed, and therefore the first braking quantity to be determined is greater than the second braking quantity.

In a further method step, the braking quantities are applied in order to brake the first and second wheels, in particular of the mobile medical apparatus. For example, the first and second braking quantities are transferred and/or provided for applying to the differential drive unit and/or to a braking unit. The differential drive unit and/or the braking unit then applies the first and second braking quantities. The first and second wheels are braked as a result of applying the first and second braking quantities. In particular, the first and second braking quantities are determined, and/or designed to be applied, such that the first and second wheels come to a standstill simultaneously. The applying of the first and second braking quantities provides in particular that these are applied simultaneously.

It is provided specifically that before the determining of the first and second braking quantities, it is checked whether the first wheel speed differs from the second wheel speed. If it is ascertained that the first and second wheel speeds are not equal and/or braking is meant to be performed, then the method steps for determining the first and second braking quantities and/or applying same are executed. If it is ascertained that the first wheel speed equals the second wheel speed, then it is preferably provided that instead of establishing two different braking quantities, a common identical braking quantity is applied, in particular a maximum permitted braking quantity. This is based on the consideration that if the speeds are the same, cornering is not taking place and then any twisting behavior of the medical apparatus and/or of the undriven wheel is not expected, and therefore the additional computational steps and/or determination steps for the first and second braking quantities do not have to be performed. Instead of, and/or in addition to, the check of whether the first wheel speed differs from the second wheel speed, the medical apparatus, in particular the chassis, can comprise a curve sensor, for instance a tilt sensor and/or a gyroscope, wherein it is ascertained on the basis of the measurement whether or not cornering is taking place. It can be provided here that if cornering is ascertained, the determining of the first and second braking quantities is applied, whereas if it is ascertained that cornering is not taking place, two separate braking quantities are not established and/or determined, but instead a common, in particular maximum permitted, braking quantity is applied to the first and second wheels.

In an optional embodiment of the invention, it is provided that in the determining of the braking quantity, a maximum braking quantity is applied and/or set for the wheel with the higher wheel speed. In other words, it can be provided that instead of calculating the determination from the first and second wheel speeds, a set and/or previously specified maximum braking quantity is applied. The maximum braking quantity is in particular a quantity that is specific to the mobile medical apparatus, specific to the chassis and/or specific to the environment, for instance for use in a hospital. In particular, the maximum braking quantity can comprise and/or form a maximum permitted acceleration, a maximum permitted braking force and/or a maximum permitted braking torque. The maximum permitted acceleration, braking force and/or braking torque is established and/or set, for example, on the basis of no hazard being expected for users, patients and/or objects and people in the environment. In particular, the maximum permitted acceleration, braking force and/or braking torque can be specific to the differential drive unit and/or the braking unit, for example based on its technical capabilities and limits. In other words, this embodiment provides that the wheel with the higher wheel speed is braked by a maximum permitted braking quantity, and the slower wheel by a braking quantity to be established and/or determined, with this braking quantity being determined on the basis of the first and/or second wheel speed, in particular on the basis of the maximum braking quantity.

It is particularly preferred that the braking quantity for the other wheel is established and/or determined on the basis of the maximum braking quantity and the first and/or second wheel speed. It is provided in particular that a braking period is determined on the basis of the higher wheel speed of the two wheel speeds and the maximum braking quantity. The braking period describes in particular the length of time needed to brake the faster wheel using the maximum braking quantity. The braking quantity for the wheel that has the lower wheel speed is determined in particular on the basis of the determined braking period of the wheel with the higher wheel speed and the wheel speed of the wheel with the lower wheel speed. In particular, the braking quantity for the wheel with the lower speed is determined such that in order to brake the wheel that has the lower wheel speed, the same braking period is needed as for the wheel with the higher wheel speed. In other words, the determining of the first and second braking quantities is performed such that when the maximum braking quantity is applied to the faster wheel, the slower wheel comes to a standstill at the same time.

It is provided in particular that the determining of the two braking quantities for the first and second wheels is performed such that the first and second wheels are braked evenly as a result of applying the braking quantities to be determined. In other words, the determining of the braking quantities is performed under the condition that the braking time of the first wheel equals the braking time of the second wheel. This condition can ensure that both wheels reach a standstill at the same point in time, and twisting behavior of the medical apparatus and/or of the undriven wheel(s) does not occur. An embodiment of the invention provides that in the determining of the first and second braking quantities, these are determined such that a wheel speed difference between the first and second wheels is reduced evenly as a result of applying the first and second braking quantities, in particular evenly over the braking phase and/or the braking period of the first and second wheels. For example, it can be provided that the difference between first and second wheel speeds is reduced linearly. It is provided specifically that a ratio of first and second wheel speeds remains constant as a result of applying the first and second braking quantities. In particular, the applying of the first and second braking quantities leads to a linear reduction in the first and second wheel speeds.

It is particularly preferred that before the determining of the first and second braking quantities, it is verified whether the first wheel and the second wheel have the same direction of rotation. For example, it is checked whether first and second wheels both have a positive or a negative wheel speed. This embodiment provides that if it is ascertained that the two wheels do not have the same direction of rotation, the step of determining the first and second braking quantities is not applied and/or executed. For example, if it is ascertained that the direction of rotation is not the same, a special braking program is initiated, an error message is output and/or the applying of braking quantities is suppressed. Alternatively and/or additionally, as a condition for executing the method step for determining the first and second braking quantities, the condition can be set that the first wheel and the second wheel have the same direction of rotation.

It is particularly preferred that in a pre-determination step is determined whether or not an activation element of the mobile medical apparatus is engaged. The activation element can comprise and/or form, for example, a dead man circuit and/or a dead man element. The activation element is intended to be engaged and/or activated by a user. For example, the activation element must be activated and/or pressed in order to be able to activate and/or use the differential drive. If the activation element is not activated, it is provided in particular to brake, in particular to brake as quickly as possible, the mobile medical apparatus. It is preferably provided here that as a condition for determining the first and second braking quantities, it is verified and required that the activation element is not activated and/or engaged. In other words, it can be provided that in the case of an activated activation element, the determination step for determining the first and second braking quantities is suppressed and/or disabled. In other words, it can be provided that the step for determining the first and second braking quantities is carried out only once the activation element is no longer engaged.

A further embodiment of the invention is a computer program, in particular a computer program product. The computer program and/or computer program product is designed and/or configured for execution on a processor, a computer and/or a controller. The computer program product and/or the computer program comprises in particular program code. When the computer program, the computer program product and/or the program code is executed, the method as described above is executed and/or is assisted by a computer implementation.

A further embodiment of the invention is a controller, in particular a controller for a mobile medical apparatus. The control apparatus is designed to execute, implement and/or assist the computer program, the computer program product and/or the method as described above. A further subject is a mobile medical apparatus, which mobile medical apparatus comprises and/or implements the control apparatus, the controller and/or the above method.

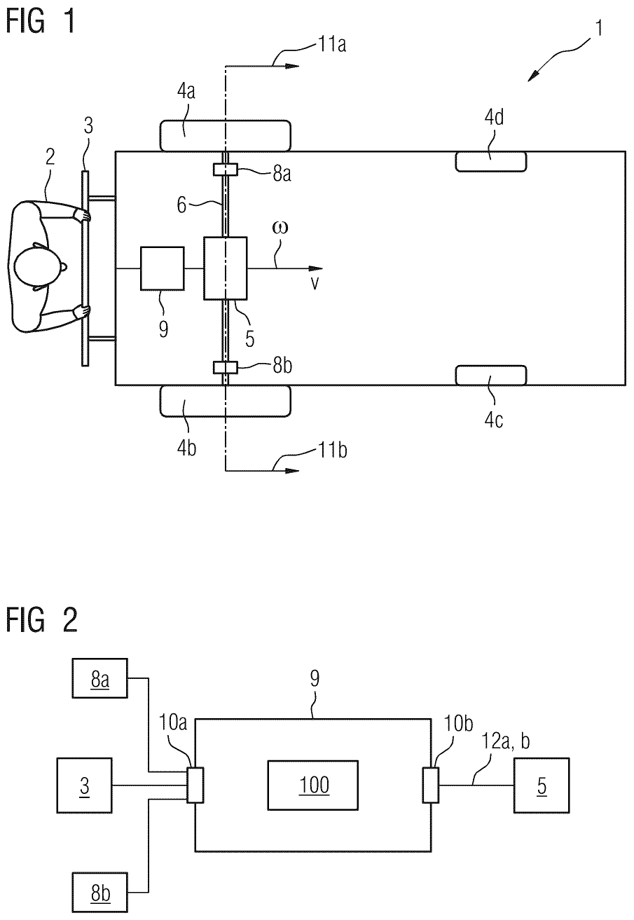

FIG. 1 shows a mobile medical apparatus 1, for example in the form of a mobile head scanner or a mobile C-arm. The actual imaging unit, for instance the C-arm, can be mounted on a movable structure. The mobile medical apparatus 1 can be controlled, in particular driven and/or steered, by a user 2. For this purpose, the mobile medical apparatus 1 comprises an operating apparatus 3, which comprises and/or forms in particular an activation element. The operating apparatus 3 can comprise force sensors, for example, which preferably serve as a dead man apparatus. In addition, the operating apparatus 3 can comprise at least one input means, for example a joystick, pushbuttons or a steering wheel, which can be used by the user 2 to control and/or steer the movement, drive and/or travel of the mobile medical apparatus 1.

The mobile medical apparatus 1 comprises a chassis which, for example, can comprise or be connected to a framework structure. The chassis and/or the mobile medical apparatus 1 comprise a plurality of wheels 4a to 4d, wherein the wheels 4a and 4b form driven wheels and the wheels 4c and 4d are co-running support wheels. The wheels 4a and 4b are connected to a differential drive unit 5, for example via an axle 6. The differential drive unit 5 is designed to drive and/or brake the wheels 4a and 4b. The differential drive unit 5 is designed to be able to drive the wheels 4a and 4b at different levels of intensity in order to facilitate cornering, for instance through the angle ω, as a result of different wheel speeds of the wheels 4a and 4b. In particular, the user 2 can set and/or select a required speed and/or can select and/or specify the steering angle ω. The mobile medical apparatus 1 comprises two sensors 8a, b, wherein the sensor 8a is designed to determine a first wheel speed 11a for the wheel 4a, and the sensor 8b is designed to determine a second wheel speed 11b for the wheel 4b. The first and second wheel speeds 11a, b are provided as data to a controller 9 of the mobile medical apparatus 1.

The operating apparatus 3 is designed to provide engagement data, which engagement data contains, for example, information about whether the activation element is activated or not activated and/or whether contact with the user 2 exists or whether the user 2 is no longer in contact with the operating apparatus 3 and no longer actively performing the control. The engagement data can further comprise user control data, which comprises a required speed and/or a steering angle.

The mobile medical apparatus 1 comprises a controller 9, which is arranged in the data stream between the operating apparatus 3 and the differential drive unit 5. The controller 9 is designed to determine and provide a first and a second braking quantity 12a, 12b for braking the mobile medical apparatus 1.

FIG. 2 shows a segment of the data and/or signal connections of the controller 9 in order to illustrate the procedures in the controller 9 and/or the method 100 executed there in this regard for determining and/or providing the braking quantities 12a, b. The controller 9 has a data connection to the operating apparatus 3 and to the differential drive unit 5. For this, the controller 9 has a data input 10a and a data output 10b. At the data input 10a, the controller 9 is provided with engagement data from the operating apparatus 3. At the data output 10b, the controller 9 provides closed-loop and/or open-loop control signals for closed-loop and/or open-loop control of the differential drive unit 5. The differential drive unit 5 responds to the provided signals by adjusting drive parameters and/or by applying the first and second braking quantities 12a, 12b.

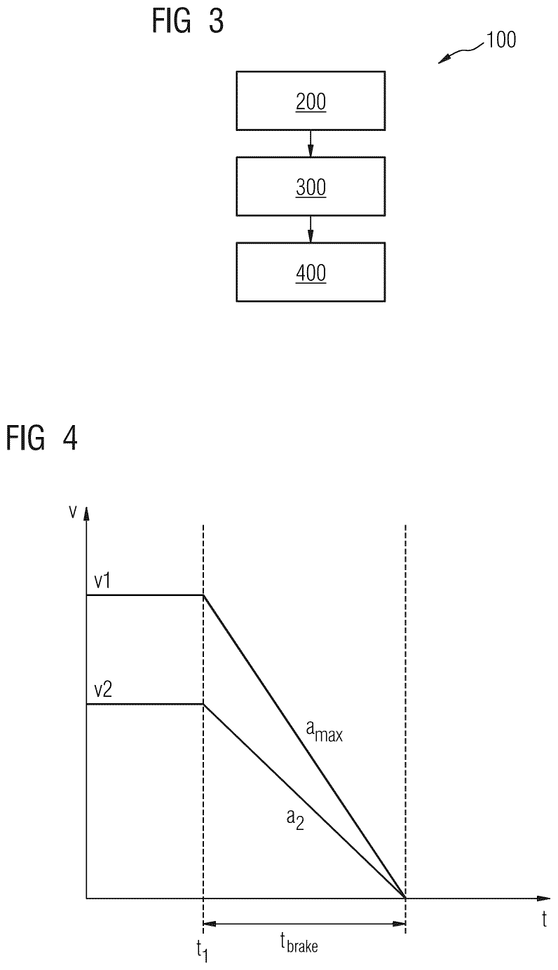

FIG. 3 shows a flow diagram as an example of the method 100 for braking a mobile medical apparatus 1. In a method step 200, a first wheel speed 11a for the first wheel 4b and a second wheel speed 11b for the second wheel 4b are determined. The determining of the wheel speeds 11a, b is performed via the sensors 8a, b, for example.

In a method step 300, the first braking quantity 12a is determined for the first wheel 4a, and a second braking quantity 12b is determined for the second wheel 4b, wherein the braking quantity 12a, b describes the strength with which an associated wheel 4a, b is braked, wherein a smaller braking quantity is determined for the wheel with the lower wheel speed than for the wheel with the higher wheel speed.

In a method step 400, the first braking quantity 12a and the second braking quantity 12b are applied in order to brake the first and second wheels 4a, b. This step comprises the providing of the first and second braking quantities 12a, b to the differential drive unit 5, which applies both braking quantities 12a, b simultaneously so that the wheels 4a, b come to a standstill simultaneously.

FIG. 4 shows by way of example the variation over time of the first and second wheel speeds (12a, 12b). The mobile medical apparatus at time t1 is in the process of cornering, with the first wheel (4a) having a higher wheel speed (12a) than the second wheel (4b). The mobile medical apparatus is performing cornering in the direction of the second wheel (4b).

At time t1, the activation element is released and the first and second braking quantities (13a, b) are determined. The method according to one or more example embodiments is used for this purpose. In step 200, the first and second wheel speeds (12a, 12b) are detected, wherein it is ascertained that the first wheel speed (12a) is greater than the second wheel speed (12b). In order to brake the faster wheel, in this case the first wheel (4a), a maximum permitted (negative) acceleration amax is applied. On the basis of the first wheel speed (12a) and the acceleration amax, in method step (300) a braking time tbrake, 1 is determined for example using tbrake, 1=amax/v1, wherein v1 stands for the tangential velocity of the first wheel (4a). In order to determine the second braking quantity (13b), it is required that applying the second braking quantity (13b) to the second wheel (4b) leads to a braking time tbrake, 2 that is equal to the braking time tbrake, 1 for the first wheel (4a). In other words, it is required that tbrake,2=tbrake, 1=a2/v2. The acceleration a2 is then determined and applied as the second braking quantity (13b).

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility (also referred to as a data processing facility) or computer device to execute the program of any of the above mentioned embodiments and/or to perform the method of any of the above mentioned embodiments.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been described in accordance with preferred embodiments, it is obvious for the person skilled in the art that modifications are possible in all embodiments.

1. A method for braking a mobile medical apparatus, wherein the mobile medical apparatus comprises a first wheel and a second wheel, the method comprising:
determining a first wheel speed for the first wheel and a second wheel speed for the second wheel;
determining a first braking quantity for the first wheel and a second braking quantity for the second wheel, the first braking quantity describing a strength with which the first wheel is braked and the second braking quantity describing a strength with which the second wheel is braked, wherein a smaller braking quantity is determined for a wheel with a lower wheel speed than for a wheel with a higher wheel speed among the first wheel and the second wheel; and
applying the first braking quantity and the second braking quantity to brake the first wheel and the second wheel.

2. The method of claim 1, wherein in the determining of the braking quantity for the wheel that has the higher wheel speed, a maximum braking quantity is applied as the braking quantity for the wheel that has the higher wheel speed.

3. The method of claim 2, wherein a braking period is determined based on the maximum braking quantity and the wheel speed of the associated wheel, wherein the braking quantity for the wheel with the lower wheel speed is based on the determined braking period and the wheel speed.

4. The method of claim 1, wherein the determining the first braking quantity and the second braking quantity determines the first braking quantity and the second braking quantity such that the first wheel and the second wheel have a same braking time as a result of applying the first braking quantity and the second braking quantity.

5. The method of claim 1, wherein the determining the first braking quantity and the second braking quantity determines the first braking quantity and the second braking quantity such that the first wheel and the second wheel come to a standstill simultaneously as a result of applying the first braking quantity and the second braking quantity.

6. The method of claim 1, wherein the determining the first braking quantity and the second braking quantity determines the first braking quantity and the second braking quantity such that a wheel-speed difference between the first wheel and the second wheel is reduced evenly over a braking phase as a result of applying the first braking quantity and the second braking quantity.

7. A method for braking a mobile medical apparatus, wherein the mobile medical apparatus comprises a first wheel and a second wheel, the method comprising:
determining a first wheel speed for the first wheel and a second wheel speed for the second wheel;
verifying whether the first wheel and the second wheel have a same direction of rotation;
determining a first braking quantity for the first wheel and a second braking quantity for the second wheel based on whether the first wheel and the second wheel have a same direction of rotation, the first braking quantity describing a strength with which the first wheel is braked and the second braking quantity describing a strength with which the second wheel is braked, wherein a smaller braking quantity is determined for a wheel with a lower wheel speed than for a wheel with a higher wheel speed among the first wheel and the second wheel; and
applying the first braking quantity and the second braking quantity or a special braking program to brake the first wheel and the second wheel, based on whether the first wheel and the second wheel have a same direction of rotation.

8. The method of claim 1, further comprising:
determining whether an activation element of the mobile medical apparatus is actuated, wherein at least one of the determining the first braking quantity and the second braking quantity or the determining the first wheel speed and the second wheel speed is performed once the activation element is no longer engaged.

9. A non-transitory computer readable medium comprising instructions, when executed by a system, causes the system to perform the method of claim 1.

10. A controller for a mobile medical apparatus, the controller being configured to cause the mobile medical apparatus to perform the method of claim 1.

11. A mobile medical apparatus comprising:
a differential drive unit;
a first wheel;
a second wheel;
the controller of claim 10; and
at least one further wheel, wherein the controller is configured to cause the differential drive unit to drive the first wheel and the second wheel.

12. The method of claim 2, wherein the maximum braking quantity is at least one of a maximum permitted acceleration, a maximum permitted braking force or a maximum permitted braking torque.

13. The method of claim 3, wherein the determining the first braking quantity and the second braking quantity determines the first braking quantity and the second braking quantity such that the first wheel and the second wheel have a same braking time as a result of applying the first braking quantity and the second braking quantity.

14. The method of claim 13, wherein the determining the first braking quantity and the second braking quantity determines the first braking quantity and the second braking quantity such that the first wheel and the second wheel come to a standstill simultaneously as a result of applying the first braking quantity and the second braking quantity.

15. The method of claim 14, wherein the determining the first braking quantity and the second braking quantity determines the first braking quantity and the second braking quantity such that a wheel-speed difference between the first wheel and the second wheel is reduced evenly over a braking phase as a result of applying the first braking quantity and the second braking quantity.

16. The method of claim 15, further comprising:
determining whether an activation element of the mobile medical apparatus is actuated, wherein at least one of the determining the first braking quantity and the second braking quantity or the determining the first wheel speed and the second wheel speed is performed once the activation element is no longer engaged.

17. The method of claim 7, further comprising:
determining whether an activation element of the mobile medical apparatus is actuated, wherein at least one of the determining the first braking quantity and the second braking quantity or the determining the first wheel speed and the second wheel speed is performed once the activation element is no longer engaged.
